(19) United States
(12) Patent Application Publication
(10) Pub. No.: US 2014/0069092 A1
(43) Pub. Date: Mar. 13, 2014

(54) Traction Control System for a Hydrostatic Drive

(71) Applicants: Christopher Mark Elliott, Apex, NC (US); William Christopher Swick, Apex, NC (US); Jeremy T. Peterson, Washington, IL (US); Paul A. Dvorak, Sanford, NC (US)

(72) Inventors: Christopher Mark Elliott, Apex, NC (US); William Christopher Swick, Apex, NC (US); Jeremy T. Peterson, Washington, IL (US); Paul A. Dvorak, Sanford, NC (US)

(73) Assignee: CATERPILLAR, INC., Peoria, IL (US)

(21) Appl. No.: 13/606,200

(22) Filed: Sep. 7, 2012

(51) Int. Cl. F15B 13/042; F04B 1/29; F04B 49/03; F15B 11/028

(52) U.S. Cl. 60/445; 91/505; 60/327; 60/451; 417/212

(57) ABSTRACT

A hydraulic pump control circuit may include a pressure reducing valve selectively operable to limit the amount of fluid pressure available to an actuator operably coupled to a pump displacement volume adjusting mechanism of a variable displacement pump. The pump may be hydraulically coupled to a motor configured to provide a torque output. The reduced pressure to the actuator limits actuator travel, thereby limiting pump displacement. Accordingly, torque output of the motor may be reduced, thereby improving traction control.

### TECHNICAL FIELD

The present disclosure is directed to machine fraction control and, more particularly, to systems and methods for controlling torque output of a hydrostatic drive.

### BACKGROUND

Some conventional machines include a power source and a power train for transferring power to drive members, such as wheels or tracks. The power train often includes a transmission coupled to the drive members, which propel the machine. A hydrostatic transmission, for example, may be used to transmit power from an engine to the drive members. In general, the hydrostatic drive may include a hydraulic circuit that includes a pump operably coupled to the engine for delivering pressurized hydraulic fluid. The hydraulic circuit may further include a motor in fluid communication with the pump that is operably coupled to one or more drive members. The motor converts the hydraulic power into a mechanical power that is output to the drive members, thereby to rotate the drive members and permit machine travel.

The pump used in some hydrostatic drives may be a variable displacement pump that can adjust the volume of hydraulic fluid that is advanced for each rotation of the pump input shaft. These pumps may use a pump displacement volume adjusting mechanism, such as a swashplate for example, that can be manipulated by an actuator to modify pump displacement. A pump displacement hydraulic circuit may be provided to control swashplate angle. The pump displacement hydraulic circuit may include a charge pump which draws hydraulic fluid from a reservoir and delivers pressurized hydraulic fluid to a pump displacement control valve, such as a forward-neutral-reverse (“FNR”) spool valve, which in turn communicates the pressurized fluid to the actuator. The pump displacement control valve may have different positions that result in different actuator responses. For example, the pump displacement control valve may have three positions: (1) a first or “forward” valve position in which the pump displacement control valve causes the actuator to move in a first direction; (2) a second or “neutral” valve position in which the pump displacement control valve causes the actuator to maintain a current actuator position; and (3) a third or “reverse” valve position in which the pump displacement control valve causes the actuator to move in a second direction opposite the first direction.

Various schemes may be employed to control swashplate angle. In a direct acting hydraulic control scheme, informally referred to as “soft” control, the command signal may represent a desired hydraulic fluid output and/or pump displacement. When using a soft control scheme, pump displacement may be influenced by the hydrostatic load encountered by the machine. That is, as the load on the hydrostatic circuit increases, such as when the machine engages a pile of dirt, pump displacement will decrease with increasing hydrostatic pressure, thereby slowing down the machine. While the soft control scheme provides advantageous pump control for adjusting machine “crowd force” (i.e., the interaction between the work material pile and the hydraulically actuated implement of the machine, and the associated hydraulics), machine velocity control may be degraded during other modes of machine operation.

Alternatively, an electronic displacement control scheme may be used to achieve greater velocity control of the machine. In electronic displacement control, informally referred to as “stiff” control, the command signal may represent a desired swashplate or actuator position. This command signal may be used to actuate the pump displacement control valve to a selected position to drive the actuator toward the desired position. The actual position of the actuator may be monitored to determine when the actuator has reached the desired position. Until the actuator reaches the desired position, the controller will continue to operate the pump displacement control valve in a manner to achieve the desired result. Should the machine encounter a load, hydrostatic pressure will increase but the controller will maintain pump displacement and adjust other components, such as transmission ratio, to maintain commanded speed. Consequently, machines that use an electronic displacement control scheme will continue to operate at maximum torque during excessive load conditions, which may cause a loss of traction or other slip conditions.

One type of system for controlling torque output is discussed in U.S. Pat. No. 8,024,925 to Cronin. Cronin teaches a system and method that use a control module to determine a desired torque output and a pressure needed to influence the displacement of the variable displacement pump to provide the desired torque output. While this approach generally provides greater control of torque output, it requires significant modification to the control algorithm employed by the machine, as well as an excessive number of additional components to implement on a machine.

### SUMMARY OF THE DISCLOSURE

In accordance with one aspect of the disclosure, a hydrostatic transmission is provided for a machine having an engine and a drive member. The hydrostatic transmission may include a variable displacement pump configured to be operably coupled to the engine, the variable displacement pump including a pump displacement volume adjusting mechanism. A motor may fluidly communicate with the pump and is operably coupled to the drive member. A reservoir of hydraulic fluid is provided and a charge pump may have a charge pump inlet fluidly communicating with the reservoir and a charge pump outlet delivering pressurized hydraulic fluid. An actuator may be operably coupled to the pump displacement volume adjusting mechanism and fluidly communicate with the charge pump outlet, the actuator having an actuator position responsive to the pressurized hydraulic fluid. A pressure reducing valve may be disposed between the charge pump and the actuator and configured to selectively reduce a pressure of the pressurized hydraulic fluid.

In another aspect of the disclosure that may be combined with any of these aspects, a hydraulic pump control circuit is provided for a variable displacement pump having a pump displacement volume adjusting mechanism. The hydraulic pump control circuit may include a reservoir of hydraulic fluid, a charge pump having a charge pump inlet fluidly communicating with the reservoir and a charge pump outlet delivering pressurized hydraulic fluid, and a pump displacement control valve having a pump displacement control valve inlet fluidly communicating with the charge pump outlet, a pump displacement control valve outlet, and a control valve element configured to selectively establish fluid communication between the pump displacement control valve inlet and the pump displacement control valve outlet. An actuator may be operably coupled to the pump displacement volume adjusting mechanism and fluidly communicate with the pump displacement control valve outlet, the actuator having an actuator position responsive to the pressurized hydraulic fluid. A pressure reducing valve may be disposed between the charge pump and the pump displacement control valve and may be configured to selectively reduce a pressure of the pressurized hydraulic fluid.

In another aspect of the disclosure that may be combined with any of these aspects, a method of controlling torque output of a hydrostatic transmission may include operating a pump having a pump displacement volume adjusting mechanism configured to vary a displacement volume of the pump, operating a motor in fluid communication with the pump, wherein the motor provide the torque output based in part on a position of the pump displacement volume adjusting mechanism, and circulating a pressurized hydraulic fluid from a source of pressurized fluid through the pump and motor. An actuator operably coupled to the pump displacement volume adjusting mechanism and in fluid communication with the source of pressurized hydraulic fluid may be operated, the actuator having a position responsive to the pressurized hydraulic fluid. The method may further include selectively reducing a pressure level of the pressurized hydraulic fluid delivered to the actuator, thereby to limit displacement of the pump displacement volume adjusting mechanism.

### BRIEF DESCRIPTION OF THE DRAWINGS

FIG. 1 is a side elevation view of a track type loader in accordance with the disclosure.

FIG. 2 is a schematic block diagram of the engine and a hydrostatic transmission of the machine shown in FIG. 2, in accordance with the disclosure.

### DETAILED DESCRIPTION

This disclosure relates to hydrostatically driven machines. In the embodiments described below, a track type loader is disclosed. It should be appreciated, however, that other types of machines can benefit from the embodiments disclosed herein. In the present embodiment, an electronic controller associated with the machine is operably connected to various machine components and systems. The controller operates in a logical fashion to transmit and receive information relative to the operation of the machine. Various sensors are located throughout the vehicle to provide information to the electronic controller concerning an operating state of the vehicle. For example, various pressure sensors may be arranged to provide information about various pressures in a drive circuit or in an implement circuit of the machine during operation. Various other sensors, such as one or more speed sensors associated with either the engine or a transmission, may provide data indicative of the rotational speed of these components to the electronic controller.

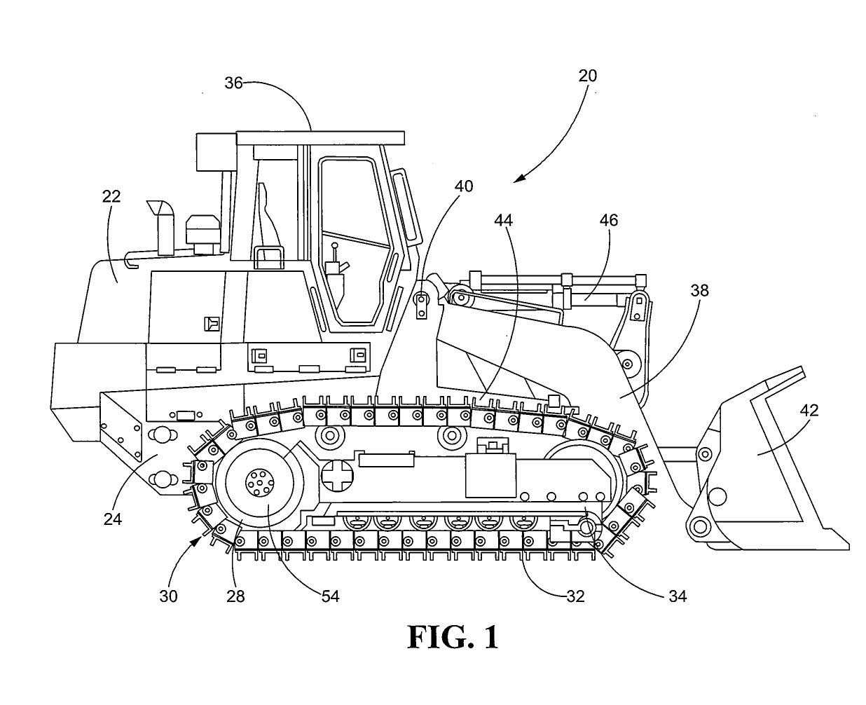

An outline view of a machine 20 is shown in FIG. 1. The term “machine” is used generically to describe any machine having a hydrostatically operated propel circuit for moving the machine across the terrain. For example, the machine may be a truck, an agricultural machine, and/or a construction machine, such as a wheel loader, a dozer, an excavator, a grader, an on-highway truck, and/or any other machine type known to a person skilled in the art. The machine 20 is shown as a track type loader for the sake of illustration only.

In the illustrated embodiment, the machine 20 may include a power source, such as an engine 22. The power source, however, may be any device that generates power, such as, for example, an internal combustion engine including but not limited to spark-ignition engines, compression ignition engines, rotary engines, gas turbine engines, and/or engines powered by gasoline, diesel fuel, bio-diesel, ethanol, methanol, and combinations thereof; hydrogen-powered engines; fuel cells; solar cells; and/or any other power source known to a person skilled in the art.

The engine 22 may be connected to a frame or chassis 24 and arranged to operate one or more hydrostatic pumps (not shown in FIG. 1) that are configured to operate one or more propel motors 54. In the exemplary embodiment, each propel motor 54 may drive a drive member, such as a gear 28, which may be meshed with a track 30. When the gear 28 rotates, the track 30 may be urged to rotate and propel the machine 20. In this type of tracked machine, the track 30 may rotate around a series of pulleys 32 and a free rotating drum 34, which align the moving track 30 with the chassis 24. As can be appreciated, the machine 20 may be propelled in either a forward or a reverse direction depending on the rotation of the gear 28. While a gear 28 is shown, other types of drive members may be used by the machine 20, including wheels, belts, tires, tracks, and/or any other device(s) for propelling a machine that are known to a person skilled in the art.

An operator cab 36 containing various controls for the machine 20 may be connected to the chassis 24. The operator cab 36 may include a seat for the operator and a series of control levers, pedals, or other devices that control the various functions of the machine 20. Lift arms 38 (only one seen in this view) may be connected to the frame of the machine 20 at a hinge 40. The lift arms 38 may pivot about the hinge 40 so that a bucket 42, or any other implement, may be raised or lowered by the machine 20. The pivotal motion of the lift arms 38 may be controlled by lift cylinders 44. In this embodiment, the bucket 42 may be tilted by tilt cylinders 46 via a linkage system. The lift cylinders 44, the tilt cylinders 46, the gear 28, and other actuators and/or motors on the machine 20 may be operated by hydraulic systems or systems selectively providing pressurized fluid to these actuators during operation.

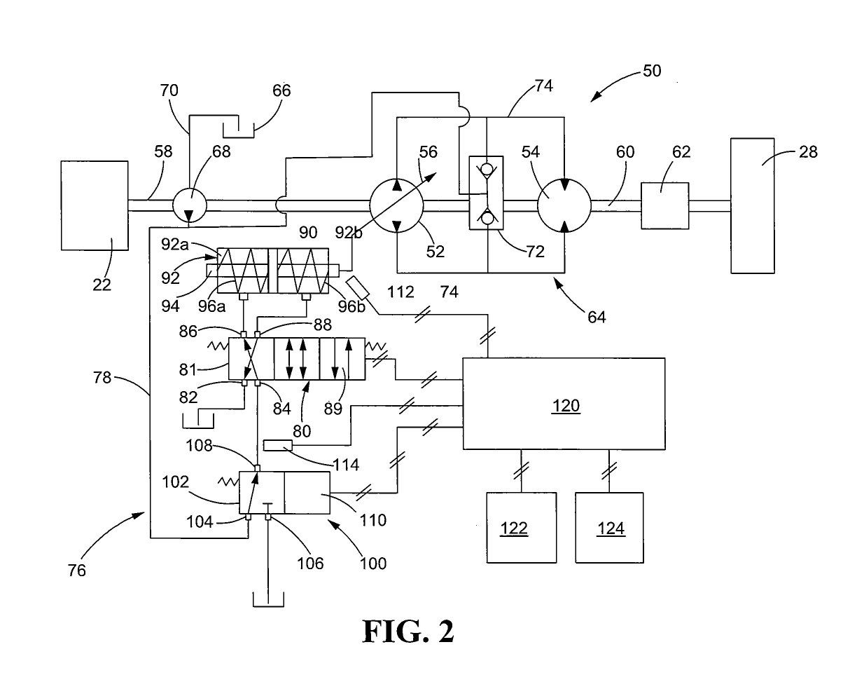

FIG. 2 schematically illustrates an exemplary embodiment of a transmission 50 configured to operably couple the engine 22 to the gears 28, thereby to propel the machine 20. The transmission 50 may be a continuously-variable transmission, such as, for example, a hydraulic transmission that includes a hydraulically-operated pump and a hydraulically-operated motor, sometimes referred to as a “hydrostatic” transmission. The illustrated hydrostatic transmission 50 shows a single hydraulic path for operating one gear 28. The hydrostatic transmission 50 may alternatively include a single hydraulic path operating multiple drive members, or may include multiple hydraulic paths that each operate a single or multiple drive members. For the sake of simplicity, however, only a single hydraulic path is shown in FIG. 2.

The transmission 50 may include a hydraulic pump 52 fluidly coupled to a hydraulic motor 54 (introduced above). As illustrated in FIG. 2, the pump 52 may have a variable displacement volume for reach cycle of the pump that is adjustable by a pump displacement volume adjusting mechanism, such as an adjustable swashplate 56. The pump 52 may be operably coupled to the engine 22, for example, by an input shaft 58. Alternatively, the pump 52 may be operably coupled to the engine 22 by a torque converter (not shown), a clutch (not shown), a gear box (not shown), or in any other manner known in the art. The transmission 50 may also include an output shaft 60 operably coupling the motor 54 to a drive member, such as the gear 28, by a final drive 62. The final drive 62 may include a reduction gear arrangement, such as a bevel gear assembly, a spur gear assembly, a planetary gear assembly, and/or any other assembly known to those having skill in the art that provides a speed reduction.

The transmission 50 may be fluidly coupled to a hydraulic circuit 64. The hydraulic circuit 64 may include a reservoir 66 configured to supply pressurized hydraulic fluid to the hydraulic circuit 64 through a charge pump 68 and a source line 70. A pressure relief valve (not shown) may be associated with the charge pump 68 to control the charge pressure level of the hydraulic fluid. The pump 52 may be configured to draw hydraulic fluid from the reservoir 66, via the source line 70, with the assistance of the charge pump 68 and a shuttle valve 72. The pump 52 may be further configured to supply hydraulic fluid to the motor 54 along hydraulic lines 74. The hydraulic lines 74 may form a closed circuit in which one of the hydraulic lines 74 carries fluid from the pump 52 to the motor 54, and the other of the hydraulic lines 74 returns hydraulic fluid from the motor 54 to the pump 52. Hydraulic fluid flowing through the motor 54 may cause the motor 54 to rotate, which may result in supplying torque to output shaft 60. The direction of fluid flow in the hydraulic circuit 64 may be reversible, such that the output shaft 60 may be driven in two directions, thereby providing the machine 20 with the ability to be driven in either a forward or reverse direction, perform pivot turns, and/or counter rotate (i.e., operate such that gears 28 on opposite sides of the machine 20 rotate in opposite directions). The transmission 50 may further include relief valves (not shown) configured to relieve pressure within the hydraulic lines 74 when the hydraulic fluid pressure exceeds a pressure limit. The pressure limit may be fixed, variable, or adjustable, and the relief valves may be cross-over relief valves configured to direct fluid from a high pressure side of the hydraulic circuit 64 to a low pressure side of the hydraulic circuit 64.

The transmission 50 may further include a hydraulic pump control circuit 76 for controlling displacement of the pump 52. The hydraulic pump control circuit 76 may include a pump control line 78 fluidly communicating with an outlet of the charge pump 68. A pump displacement control valve 80 may have a housing 81 defining a first inlet 82 fluidly communicating with the charge pump 68 and a second inlet 84 fluidly communicating with a low pressure environment, such as the reservoir 66. The housing 81 may also define first and second outlets 86, 88.

A control valve element 89 may be disposed in the housing 81 and configured to have multiple positions for selectively establishing fluid communication between the first and second inlets 82, 84 and the first and second outlets 86, 88. In the exemplary embodiment, the pump displacement control valve 80 may be configured as a forward-neutral-reverse, or FNR, valve, in which the control valve element 89 is configured as a FNR spool. As such, the control valve element 89 may have a first or “forward” position in which the second inlet 84 fluidly communicates high pressure hydraulic fluid to the first outlet 86 and the first inlet 82 fluidly communicates low pressure to the second outlet 88. The control valve element 89 may also have a second or “neutral” position in which the first and second outlets 86, 88 are blocked from fluid communication with the first and second inlets 82, 84. Still further, the control valve element 89 may have a third or “reverse” position in which the first inlet 82 fluidly communicates with the first outlet 86 and the second inlet 84 fluidly communicates with the second outlet 88.

The exemplary hydraulic pump control circuit 76 may also include an actuator 90 that may be operably coupled to the swashplate 56 to vary the displacement of the pump 52. The actuator 90 may include an actuator chamber 92 defining first and second chamber portions 92a, 92b. A rod 94 may extend through both chamber portions 92a, 92b and may have an end coupled to the swashplate 56. First and second resilient members, such as springs 96a, 96b, may be disposed in respective chamber portions 92a, 92b to bias the rod 94 toward a neutral position.

The actuator 90 may be fluidly coupled to the pump displacement control valve 80 so that a position of the rod 94 is responsive to the pressurized hydraulic fluid provided by the charge pump 68. More specifically, the first and second chamber portions 92a, 92b may fluidly communicate with respective the first and second outlets 86, 88 of the pump displacement control valve 80. Accordingly, when the control valve element 89 of the pump displacement control valve 80 is in the first/forward position, high pressure may be communicated to the first chamber portion 92a while the second chamber portion 92b may be permitted to drain to the pump case, thereby driving the actuator rod 94 in a first direction (to the right in FIG. 2) to pivot the swashplate 56 in a forward direction. Additionally, when the control valve element 89 is in the second/neutral position, the first and second chamber portions 92a, 92b may be closed off from fluid communication with the pump displacement control valve 80 and therefore may maintain their respective pressure levels, thereby to hold the swashplate 56 in the current position. Still further, when the control valve element 89 is in the third/reverse position, high pressure may be communicated to the second chamber portion 92b while the first chamber portion 92a may drain to the pump case, thereby driving the actuator rod 94 in a second direction (to the left in FIG. 2) to pivot the swashplate in a reverse direction.

The hydraulic pump control circuit 76 may further include a pressure reducing valve 100 for selectively limiting the amount of hydraulic fluid pressure available for use by the actuator 90, thereby effectively limiting the amount of pump displacement. As best shown in FIG. 2, the pressure reducing valve 100 may be disposed between the charge pump 68 and the pump displacement control valve 80. The pressure reducing valve 100 may include a housing 102 defining a first inlet 104 fluidly communicating with the charge pump 68, a second inlet 106 fluidly communicating with a low pressure environment, such as the pump case, and an outlet 108 fluidly communicating with the second inlet 84 of the pump displacement control valve 80. A pressure reducing valve element 110 may be disposed in the pressure reducing valve housing 102 and may be configured to establish fluid communication between the outlet 108 and a selected one of the first and second inlets 104, 106. Specifically, the pressure reducing valve element 110 may have a first position, in which pressurized hydraulic fluid is communicated from the first inlet 104 to the outlet 108, and a second position in which the outlet 108 fluidly communicates with the low pressure environment. Thus, when the pressure reducing valve element 110 is in the second position, the fluid pressure available to the actuator 90 may be reduced and the amount of pump displacement is limited.

The exemplary machine 20 may include one or more sensors configured to provide signals indicative of a parameter related to operation of the machine 20 and/or one of its systems. For example, the machine 20 may include a pump displacement sensor 112 configured to provide a signal indicative of a displacement volume of the pump 52. The pump displacement sensor 112 may include a travel sensor (as shown) configured to provide a signal indicative of a position of the actuator rod 94, may be a sensor configured to directly determine a position of the swashplate 56, or may be any other sensor that directly or indirectly determines the displacement volume of the pump 52. Additionally, the machine 20 may include a pressure sensor 114 configured to provide a signal indicative of a pressure level of the hydraulic fluid downstream of the pressure reducing valve outlet 108. Other pressure sensors (not shown) may be provided throughout the hydraulic circuit 64, the hydraulic pump control circuit 76, or other systems on the machine to provide additional feedback. The machine 20 may further include one or more sensors related to the operation of the engine 22, such as engine control sensors (not shown), an engine speed sensor (not shown), a throttle input sensor (not shown), or any other sensors known to those having skill in the art.

According to some embodiments, the machine 20 may include a controller 120. As shown in FIG. 2, the controller 120 may be configured to control operation of the engine 22 and/or the transmission 50. For example, the controller 120 may be configured to control the transmission 50 by supplying control signals for operating the pump 52 and the motor 54. In particular, the controller 120 may control fluid flow in the transmission 50 by, for example, controlling displacement of the pump 52 and/or motor 54. The controller 120 may control the position of the control valve element 89 of the pump displacement control valve 80 (which, in turn, affects the position of the actuator rod 94) by supplying a displacement command signal that actuates the control valve element 89 from the neutral position to either the forward or reverse positions. The controller may monitor actuator rod position using feedback from the travel sensor 112 and modify the displacement command signal as needed until the actuator rod 94 reaches a desired position, at which time the control valve element 89 is returned to the neutral position. The controller 120 may further control the position of the pressure reducing valve element 110 of the pressure reducing valve 100 by supplying a pressure reducing valve command signal indicative of a desired position of the pressure reducing valve element 110. The pressure reducing valve command signal may be an open loop command to actuate the pressure reducing valve element 110 to the first or second positions, or the command may represent a desired pressure level, in which case the controller 120 may monitor a pressure level downstream of the pressure reducing valve 100 using feedback from the pressure sensor 114 and modify the pressure reducing valve command signal as needed until the desired pressure level is reached.

An operator interface 122 may be configured for providing operator input to the controller 120. The operator interface 122 may be configured as a speed direction control lever, left and/or right steering pedals, a brake pedal, an implement lever, an implement switch, or other operator interfaces known to those skilled in the art, or combinations thereof, used to control movement of the machine 20 and/or an implement associated therewith. The machine 20 may also include an override input 124 for manually controlling operation of the pressure reducing valve 100.

The controller 120 may control displacement of the pump 52 and motor 54 based on signals received from the operator interface 122, the travel sensor 112, the pressure sensor 114, engine control sensor (not shown), and/or other sensors that may be provided on the machine 20. Such signals may be in the form of digital, analog, mechanical, and/or hydraulic signals. For example, operator interface 122 may provide a signal indicative of an operator's steering command that is received by the controller 120. Further, the travel sensor 112 may provide a signal indicative of the position of the actuator rod 94, and/or the pressure sensor 114 may provide a signal indicative of the pressure level downstream of the pressure reducing valve 100. One or more of these signals from the operator interface 122 and the sensors 112, 114 may be received by the controller 120, and the controller 120 may be configured to control fluid flow in the transmission 50 based, at least in part, on these signals. By controlling the fluid flow, the controller 120 may operate to control the magnitude of the power supplied to one or more drive members, such as the gear 28.

According to some exemplary embodiments, the controller 120 may be configured to reduce hydraulic fluid pressure downstream of the pressure reducing valve 100. Pressure reduction may be initiated manually by the user, such as by actuating the override input 124 to an active position. Additionally or alternatively, pressure reduction may be initiated automatically based on sensed operation parameters of the machine 20 and/or the transmission 50. During pressure reduction, the controller 120 may actuate the pressure reducing valve element 110 to one of the first and second positions, or may modulate the pressure reducing valve element 110 between first and second positions to achieve a desired lower pressure level downstream of the pressure reducing valve 100. Feedback indicative of actual pressure level may be provided to the controller 120 by the pressure sensor 114. By reducing the fluid pressure available to the actuator 90, the amount of travel of the actuator rod 94 may be limited, thereby reducing the amount of pump displacement. The reduced pump displacement may reduce the amount of torque produced by the motor 54, thereby permitting less than maximum torque even when the controller 120 is operated using an electronic displacement control scheme in which the displacement command signal is reliant primarily on the position of the actuator rod 94.

The controller 120 may include any components that may be used to run an application, such as, for example, a memory, a secondary storage device, and/or a central processing unit. According to some embodiments, the controller 120 may include additional or different components, such as, for example, mechanical and/or hydro-mechanical components. Various other known components may be associated with the controller 120, such as, for example, power supply circuitry, signal-conditioning circuitry, solenoid driver circuitry, and/or other appropriate circuitry. Such circuits may be electrical and/or hydro-mechanical.

### INDUSTRIAL APPLICABILITY

Systems and methods are disclosed for reducing torque to a drive member when using an electronic displacement control scheme. These systems and methods may be applicable to any type of machine, such as machines having one or more hydrostatic transmissions operably coupled to the drive members. Such machines may include two hydrostatic transmissions, each of which may be operably coupled to a drive member located on a respective side of the machine. The machine may include a hydraulic circuit, and each of the hydrostatic transmissions may include a hydraulic pump and a hydraulic motor fluidly coupled to the hydraulic circuit. The hydrostatic transmissions may transfer torque supplied by a power source, such as an internal combustion engine, to the drive members. The amount of torque transferred by the hydrostatic transmissions may be controlled by a controller that controls the flow of fluid in the hydraulic circuit and/or in the pumps and motors of the hydrostatic transmissions.

The controller 120 may be configured to, among other things, initiate a pressure reduction in the hydraulic fluid supplied to an actuator 90 of a variable displacement pump 52. For example, the controller 120 may selectively reduce a pressure level of the pressurized hydraulic fluid delivered to the actuator 90 by modulating a position of a pressure reducing valve element 110, thereby to limit displacement of the pump 52. Thus, output torque from the motor 54 fluidly coupled to the pump 52 may be reduced, even when the controller 120 uses an electronic displacement control scheme, in which a position of the actuator rod 94 is primarily used in a feedback control loop to provide a command signal to a pump displacement control valve 80. More specifically, the pressure reducing valve 100, when activated, may reduce the pressure of hydraulic fluid reaching the actuator 90 regardless of the position of the pump displacement control valve 80. Accordingly, the travel range of the actuator rod 94 may be reduced, thereby limiting pump displacement.

Selective reduction of the hydraulic fluid pressure to limit pump displacement and reduce motor torque output may be advantageous in a number of operating conditions. For example, the pressure reduction may be used to control crowd force of the machine. In one aspect, crowd force may be modulated by selectively reducing fluid pressure (and therefore torque output), which may be advantageous when handling sensitive material. In another aspect, selective reduction of fluid pressure and torque output may allow the operator to directly limit track/wheel slip during material acquisition cycles. Additionally or alternatively, selectively reducing fluid pressure and torque output may limit machine acceleration and deceleration during FNR valve shifts and slope changes, thereby providing greater acceleration control of the machine 20. In each of these operations, the use of the pressure reducing valve may produce less than the maximum pressure available to the drive member, and therefore a lower tractive effort.

The pressure override systems and methods may be implemented with minimal modification of existing hydrostatic transmission design, as only a pressure reducing valve 100 need be added for each hydrostatic path. The system may be operated with open loop controls, without the pressure sensor 114, thereby further minimizing the number of additional components. Additionally, minimal control algorithm changes may be needed.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A hydrostatic transmission for a machine having an engine and a drive member, the hydrostatic transmission comprising:
a variable displacement pump configured to be operably coupled to the engine, the variable displacement pump including a pump displacement volume adjusting mechanism;
a motor fluidly communicating with the pump and operably coupled to the drive member;
a reservoir of hydraulic fluid;
a charge pump having a charge pump inlet fluidly communicating with the reservoir and a charge pump outlet delivering pressurized hydraulic fluid;
an actuator operably coupled to the pump displacement volume adjusting mechanism and fluidly communicating with the charge pump outlet, the actuator having an actuator position responsive to the pressurized hydraulic fluid; and
a pressure reducing valve disposed between the charge pump and the actuator and configured to selectively reduce a pressure of the pressurized hydraulic fluid.

2. The hydrostatic transmission of claim 1, further including a pump displacement control valve having an a pump displacement control valve inlet fluidly communicating with the charge pump outlet, a pump displacement control valve outlet fluidly communicating with the actuator, and a control valve element configured to selectively establish fluid communication between the pump displacement control valve inlet and the pump displacement control valve outlet, and wherein the pressure reducing valve is further disposed between the charge pump and the pump displacement control valve.

3. The hydrostatic transmission of claim 2, further including a controller operably coupled to the pump displacement control valve and configured to communicate a displacement command signal indicative of a desired position of the control valve element to the pump displacement control valve, and wherein the displacement command signal is determined primarily by a position of the actuator.

4. The hydrostatic transmission of claim 3, wherein the controller is operably coupled to the pressure reducing valve and configured to communicate a pressure reducing valve command to selectively actuate the pressure reducing valve.

5. The hydrostatic transmission of claim 1, wherein the pump displacement volume adjusting mechanism includes an adjustable swashplate.

6. The hydrostatic transmission of claim 1, wherein the pressure reducing valve comprises a pressure reducing valve element having a first position, in which the pressurized hydraulic fluid from the charge pump is communicated to the actuator, and a second position, in which a low pressure tank is communicated to the actuator.

7. The hydrostatic transmission of claim 6, further including a controller operably coupled to the pressure reducing valve and configured to modulate the pressure reducing valve element between the first and second positions to obtain a desired hydraulic fluid pressure level.

8. A hydraulic pump control circuit for a variable displacement pump having a pump displacement volume adjusting mechanism, the hydraulic pump control circuit comprising:
a reservoir of hydraulic fluid;
a charge pump having a charge pump inlet fluidly communicating with the reservoir and a charge pump outlet delivering pressurized hydraulic fluid;
a pump displacement control valve having a pump displacement control valve inlet fluidly communicating with the charge pump outlet, a pump displacement control valve outlet, and a control valve element configured to selectively establish fluid communication between the pump displacement control valve inlet and the pump displacement control valve outlet;
an actuator operably coupled to the pump displacement volume adjusting mechanism and fluidly communicating with the pump displacement control valve outlet, the actuator having an actuator position responsive to the pressurized hydraulic fluid; and
a pressure reducing valve disposed between the charge pump and the pump displacement control valve and configured to selectively reduce a pressure of the pressurized hydraulic fluid.

9. The hydraulic pump control circuit of claim 8, further including a controller operably coupled to the pump displacement control valve and configured to communicate a displacement command signal indicative of a desired position of the control valve element to the pump displacement control valve, and wherein the displacement command signal is determined primarily by a position of the actuator.

10. The hydraulic pump control circuit of claim 9, wherein the controller is operably coupled to the pressure reducing valve and configured to communicate a pressure reducing valve command to selectively actuate the pressure reducing valve.

11. The hydraulic pump control circuit of claim 8, wherein the pump displacement volume adjusting mechanism includes an adjustable swashplate.

12. The hydraulic pump control circuit of claim 8, wherein the pressure reducing valve comprises a pressure reducing valve element having a first position, wherein the pressurized hydraulic fluid from the charge pump is communicated to the actuator, and a second position, wherein a low pressure tank is communicated to the actuator.

13. The hydraulic pump control circuit of claim 12, further including a controller operably coupled to the pressure reducing valve and configured to modulate the pressure reducing valve element between the first and second positions to obtain a desired hydraulic fluid pressure level.

14. A method of controlling torque output of a hydrostatic transmission, comprising:
operating a pump having a pump displacement volume adjusting mechanism configured to vary a displacement volume of the pump;
operating a motor in fluid communication with the pump, wherein the motor provide the torque output based in part on a position of the pump displacement volume adjusting mechanism;
circulating a pressurized hydraulic fluid from a source of pressurized fluid through the pump and motor;
operating an actuator operably coupled to the pump displacement volume adjusting mechanism and in fluid communication with the source of pressurized hydraulic fluid, the actuator having a position responsive to the pressurized hydraulic fluid;
selectively reducing a pressure level of the pressurized hydraulic fluid delivered to the actuator, thereby to limit displacement of the pump displacement volume adjusting mechanism.

15. The method of claim 14, further including operating a pump displacement control valve having a pump displacement control valve inlet in fluid communication with the source of pressurized fluid, a pump displacement control valve outlet fluidly communicating with the actuator, and a control valve element configured to selectively establish fluid communication between the pump displacement control valve inlet and the pump displacement control valve outlet.

16. The method of claim 15, wherein selectively reducing the pressure level includes communicating a displacement command signal to the pump displacement control valve, and wherein the displacement command signal is indicative of a desired position of the control valve element and is determined primarily by a position of the actuator.

17. The method of claim 16, wherein selectively reducing the pressure level further includes communicating a pressure reducing valve command to selectively actuate a pressure reducing valve disposed between the source of pressurized fluid and the actuator.

18. The method of claim 17, wherein the pressure reducing valve includes a pressure reducing valve element having a first position, wherein the pressurized hydraulic fluid from the source of pressurized fluid is communicated to the actuator, and a second position, wherein a low pressure tank is communicated to the actuator.

19. The method of claim 18, further including modulating the pressure reducing valve element between the first and second positions to obtain a desired hydraulic fluid pressure level.

20. The method of claim 14, wherein the pump displacement volume adjusting mechanism includes an adjustable swashplate.
